(19) United States
(12) Patent Application Publication
(10) Pub. No.: US 2006/0277359 A1
(43) Pub. Date: Dec. 7, 2006

(54) Blank memory location detection mechanism

(76) Inventor: Robert W. Faber, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/147,035

(22) Filed: Jun. 6, 2005

(51) Int. Cl. G06F 13/00; G06F 12/00

(52) U.S. Cl. 711/113; 711/103

(57) ABSTRACT

Briefly, a memory word in non-volatile memory includes data and a signature. The signature is used to verify whether the memory word contains valid data. A management table tracking blank and/or non-blank memory words is built after a system crash detection.

### BACKGROUND

### DESCRIPTION OF THE RELATED ART

The use of a cache in a computer reduces memory access time and increases the overall speed of a device. Typically, a cache is an area of memory which serves as a temporary storage area for a device and has a shorter access time than the device it is caching. Data frequently accessed by the processor remain in the cache after an initial access. Subsequent accesses to the same data may be made to the cache.

Two types of caching are commonly used, memory caching and disk caching. A memory cache, sometimes known as cache store, is typically a high-speed memory device such as a static random access memory (SRAM). Memory caching is effective because most programs access the same data or instructions repeatedly.

Disk caching works under the same principle as memory caching but uses a conventional memory device such as a dynamic random access memory (DRAM). The most recently accessed data from the disk is stored in the disk cache. When a program needs to access the data from the disk, the disk cache is first checked to see if the data is in the disk cache. Disk caching can significantly improve the performance of applications because accessing a byte of data in RAM can be thousands of times faster than accessing a byte on a disk.

Both the SRAM and DRAM are volatile memories. Therefore, in systems using a volatile memory as the cache memory, data stored in the cache memory would be lost when the power is shut off to the system. Accordingly, some devices may utilize non-volatile memory.

Certain non-volatile memories, such as polymer memory, are destructive read memories. Data stored in a memory location of destructive read memories are erased by the process of reading the memory location. Further, a polymer memory location can only be written in one direction, for example, from a one to a zero, but not from a zero to a one. Thus, a polymer memory location must be erased or blank prior to writing new data to the memory location.

Applications utilizing destructive read memories would have to track erased or blank memory locations. However, upon a loss of system power or other event, blank memory location information may be lost preventing system recovery or causing significant loss of data.

### BRIEF DESCRIPTION OF THE DRAWINGS

The present invention may be better understood, and its numerous features and advantages made apparent to those skilled in the art by referencing the accompanying drawings.

FIG. 1 illustrates portions of a polymer memory device according to an embodiment of the present invention.

FIG. 2 illustrates a memory word format according to an embodiment of the present invention.

FIG. 3 illustrates a blank detection flow according to an embodiment of the present invention.

FIG. 4 illustrates a system according to an embodiment of the invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As disclosed herein, a “cache” refers to a temporary storage area and can be either a memory cache or a disk cache. The term “system boot” refers to initialization of a computer both when the power is first turned on, known as cold booting, and when a computer is restarted, known as warm booting. The term “computer readable medium” includes, but is not limited to portable or fixed storage devices, optical storage devices, and any other memory devices capable of storing computer instructions and/or data. The term “computer instructions” are software or firmware including data, codes, and programs that can be read and/or executed to perform certain tasks.

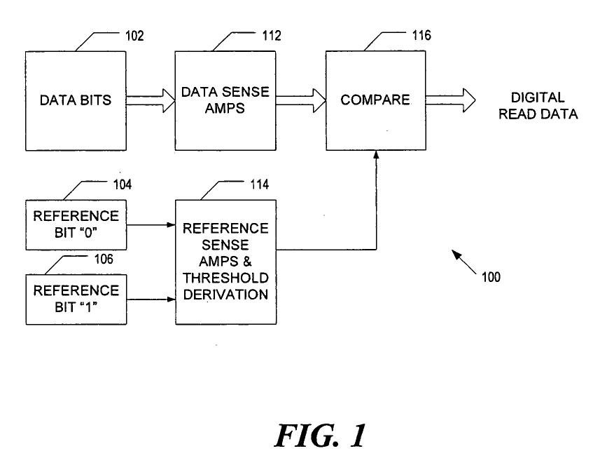

FIG. 1 illustrates portions of a polymer memory device 100 according to an embodiment of the present invention. Polymer memory device 100 includes data bits 102 and reference bits 104 and 106. Data bits 102 may be an entire memory word wide, for example, 4K bytes. Reference bit 104 represents a “zero” and reference bit 106 represents a “one.” Reference bits 104 and 106 are used to set an analog read voltage threshold for comparing against and determining the stored values of data bits 102. The threshold is derived by averaging voltage levels of reference bits 104 and 106.

During a read operation, data bits 102 are sensed by data sense amplifiers 112 and reference bits 104 and 106 are sensed and processed by reference sense amplifier and threshold derivation circuitry 114. The outputs of the data sense amplifiers 112 and reference sense amplifier and threshold derivation circuitry 114 are compared by comparison circuitry 116 to determine the digital read data.

Reading a memory word in polymer memory device 100 erases the memory cells of the word, including data bits 102 and reference bits 104 and 106, leaving the word in a blank state, for example, all ones. A memory word in a blank state will return random results when read because an improper threshold will be derived. Thus, the location of blank memory words should be managed to preserve data and aid in system recovery after a power loss or crash event.

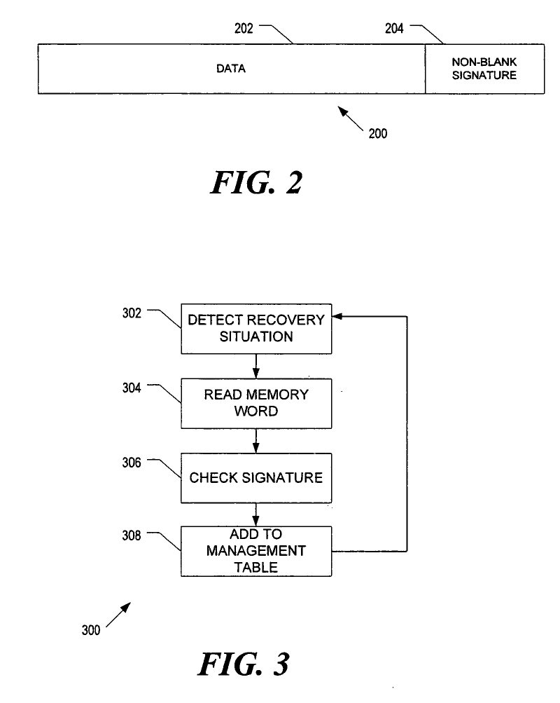

FIG. 2 illustrates a memory word format according to an embodiment of the present invention. Memory word format 200 includes data 202 and non-blank signature 204. Non-blank signature 204 may be an error correcting code (ECC) protected non-blank signature. The ECC protected signature may be written as a part of every memory word, indicating that the memory word is non-blank. The signature may be selected, taking advantage of memory-specific behavior, to meet a required minimum probability of false non-blank detection. During normal operation the location of blank memory words is known and this signature is not used. During crash recovery or other times that the location of blank memory words is not known, the non-blank signature is confirmed for all memory words to rebuild a management table tracking blank and/or non-blank memory words.

FIG. 3 illustrates a blank detection flow 300 according to an embodiment of the present invention. A system recovery situation is detected, block 302. A system recovery situation may occur after a system crash or an unexpected power loss. A memory word is read, block 304. The memory word is verified as having valid data by checking the non-blank signature, block 306. Blank and/or non-blank tracking information is added to a management table, block 308. According to one embodiment of the present invention, a memory management table includes a listing of blank memory words. In an alternate embodiment, the management table includes a listing of non-blank memory words. The invention is not limited in this respect. The next memory word is read, block 302, until all memory words have been processed and all blank memory words have been identified.

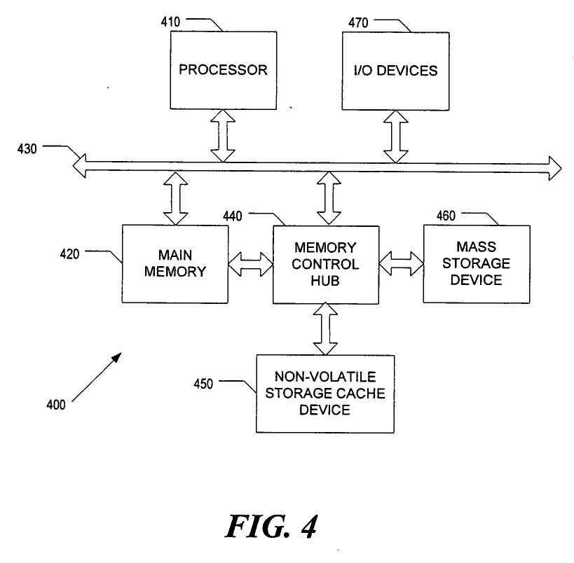

FIG. 4 illustrates a system 400 according to an embodiment of the present invention. System 400 includes a processor 410 coupled to a main memory 420 by a bus 430. Main memory 410 may include a random-access-memory (RAM) and be coupled to a memory control hub 440. Memory control hub 440 may also be coupled to bus 430, to a nonvolatile storage cache device 450 and to a mass storage device 460. Mass storage device 460 may be a hard disk drive, a floppy disk drive, a compact disc (CD) drive, a Flash memory (NAND and NOR types, including multiple bits per cell), a ferroelectric RAM (FRAM), or a polymer FRAM (PFRAM) or any other existing or future memory device for mass storage of information. Memory control hub 440 controls the operations of main memory 420, non-volatile storage cache device 450 and mass storage device 460. Finally, a number of input/output devices 470 such as a keyboard, mouse and/or display may be coupled to bus 430.

Although system 400 is illustrated as a system with a single processor, other embodiments may be implemented with multiple processors, in which additional processors may be coupled to the bus 430. In such cases, each additional processor may share the non-volatile storage cache device 450 and main memory 420 for writing data and/or instructions to and reading data and/or instructions from the same. Also, although non-volatile storage cache device 450 is shown external to mass storage device 460, in other embodiments non-volatile storage cache device 450 may be internally implemented into any non-volatile media in a system. For example, in one embodiment, non-volatile storage cache device 450 may be a portion of mass storage device 460.

Because retrieving data from mass storage device 460 can be slow, caching may be achieved by storing data recently accessed from the mass storage device 460 in a non-volatile storage media such as non-volatile storage cache device 450. The next time the data is needed, it may be available in non-volatile storage cache device 450, thereby avoiding a time-consuming search and fetch in mass storage device 460. Non-volatile storage cache device 450 may also be used for writing. In particular, data may be written to non-volatile storage cache device 450 at high speed and then stored until the data is written to mass storage device 460, for example, during idle machine cycles or idle cycles in a mass storage subsystem.

According to one embodiment of the present invention, a memory controller, for example, memory control hub 440, handles blank detection and builds a management table tracking blank and/or non-blank memory words. Software enables blank detection only when necessary, for example, during reads when blank locations are not known.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. An apparatus comprising:
a memory controller to access a non-volatile memory device, the memory controller having blank detection circuitry to determine if a memory word in the non-volatile memory device contains valid data.

2. The apparatus as recited in claim 1, wherein the blank detection circuitry further to verify a signature stored in the memory word is valid.

3. The apparatus as recited in claim 2, wherein the signature is verified after a crash situation has occurred.

4. The apparatus as recited in claim 2, wherein the signature is not verified during normal operation.

5. The apparatus as recited in claim 2, wherein the signature is error corrective coding (ECC) protected.

6. The apparatus as recited in claim 1, the memory controller further to build a blank management table.

7. The apparatus as recited in claim 6, the blank management table including a list of non-blank memory words in the non-volatile memory.

8. The apparatus as recited in claim 6, the blank management table including a list of blank memory words in the non-volatile memory.

9. A method comprising:
determining if a memory word is blank; and
based on a result of the determining, adding information to a management table; and
repeating the determining and the adding for each other memory word in a non-volatile memory.

10. The method as recited in claim 9, wherein the determining if the memory word is blank comprises:
reading the memory word; and
verifying a signature in the memory word.

11. The method as recited in claim 10, wherein the memory word includes the signature and data.

12. The method as recited in claim 10, further comprising storing the signature and data in the memory location if the memory location is non-blank.

13. The method as recited in claim 10, wherein the signature, if verified, indicates that the memory location is not blank.

14. The method as recited in claim 10, wherein the signature is error corrective coding (ECC) protected.

15. A program loaded in a computer readable medium comprising:
a first group of instructions to determine if a memory word is blank;
a second group of instructions to add information to a management table based on a result of the determining; and
a third group of instructions to repeat the first group of instructions and second group of instructions for each other memory word in a non-volatile memory.

16. The program as recited in claim 15, wherein the first group of instructions comprises:
a fourth group of instructions to read the memory word; and
a fifth group of instructions to verify a signature in the memory word.

17. The program as recited in claim 15, wherein the memory word includes the signature and data.

18. The program as recited in claim 15, further comprising a sixth group of instructions to store the signature and data in the memory location if the memory location is non-blank.

19. The program as recited in claim 15, wherein the signature, if verified, indicates that the memory location is not blank.

20. The program as recited in claim 15, wherein the signature is error corrective coding (ECC) protected.

21. A system comprising:
a non-volatile storage media; and
a memory controller to access the non-volatile storage media, the memory controller having blank detection circuitry to determine if a memory word in the non-volatile storage media contains valid data.

22. The system as recited in claim 21, wherein the blank detection circuitry further to verify a signature stored in the memory word is valid.

23. The system as recited in claim 22, wherein the signature is verified after a crash situation has occurred.

24. The system as recited in claim 22, wherein the signature is not verified during normal operation.

25. The system as recited in claim 21, the memory controller further to build a blank management table.

26. The system as recited in claim 25, the blank management table including a list of non-blank memory words in the non-volatile memory.

27. The system as recited in claim 25, the blank management table including a list of blank memory words in the non-volatile memory.
